(19) United States
(12) Patent Application Publication
(10) Pub. No.: US 2016/0079620 A1
(43) Pub. Date: Mar. 17, 2016

(54) HYDROGEN PURGING DEVICE AND METHOD FOR FUEL CELL SYSTEM

(71) Applicant: HYUNDAI MOTOR COMPANY, Seoul (KR)

(72) Inventor: Ik Jae Son, Suwan (KR)

(21) Appl. No.: 14/569,733

(22) Filed: Dec. 14, 2014

(30) Foreign Application Priority Data
Sep. 16, 2014 (KR) 10-2014-0122526

(51) Int. Cl. H01M 8/04

(52) U.S. Cl. CPC H01M 8/04753; H01M 8/0491; H01M 8/04746; H01M 8/04992; H01M 2250/20

(57) ABSTRACT

A hydrogen purging device and method for a fuel cell system are provided in which the opening/closing of a hydrogen purge valve is variably controlled based on a purge charge amount depending on an operating state of a fuel cell in the fuel cell system to improve the hydrogen utilization factor of the fuel cell, system efficiency, hydrogen circulation performance, and the like. The hydrogen purging device includes an operating state detector that detects an operating state of a fuel cell stack and a controller that determines an opening time of a hydrogen purge valve based on information regarding the stack operating state detected by the operating state detector. The controller then outputs a control signal to open the hydrogen purge valve. When the hydrogen purge valve is opened the hydrogen purging of the fuel cell stack is performed in response to the control signal output from the controller.

### CROSS-REFERENCE TO RELATED APPLICATION

This application claims under 35 U.S.C. §119(a) the benefit of Korean Patent Application No. 10-2014-0122526 filed on Sep. 16, 2014, the entire contents of which are incorporated herein by reference.

### BACKGROUND

(a) Technical Field

The present disclosure relates to a hydrogen purging device and method for a fuel cell system. More particularly, it relates to a hydrogen purging device and method which increase the hydrogen utilization factor of a fuel cell and the efficiency of a fuel cell system.

(b) Background Art

A fuel cell system applied to a hydrogen fuel cell vehicle, a type of environmentally friendly vehicle, includes a fuel cell stack configured to generate electrical energy from an electrochemical reaction of reactant gases (e.g., hydrogen as a fuel and oxygen as an oxidizer), a hydrogen supply device configured to supply hydrogen as a fuel to the fuel cell stack, an air supply device configured to supply air including oxygen to the fuel cell stack, a heat and water management system configured to adjust the operating temperature of the fuel cell stack and perform a water management function, and a fuel cell system controller configured to operate the fuel cell system.

FIG. 1 is an exemplary schematic diagram illustrating a general fuel cell system. A hydrogen supply device includes a hydrogen storage (hydrogen tank) 21, high pressure/low pressure regulators (not show), a hydrogen supply valve 23, a hydrogen recirculation device, and the like. An air supply device includes an air blower 31, a humidifier 32, and the like. A heat and water management system (not shown) includes an electric water pump (cooling water pump), a water tank, a radiator, and the like.

High-pressure hydrogen supplied from the hydrogen tank 21 of the hydrogen supply device sequentially passes through the high pressure/low pressure regulators (not shown) and is then supplied at lower pressure to a fuel cell stack 10. In the hydrogen recirculation device, an ejector 25 and/or a recirculation blower is installed in a recirculation line 24 to recirculate non-reaction hydrogen remaining after being used in a hydrogen electrode (anode) of the fuel cell stack 10 to the anode, to thus promote reuse of the hydrogen. The air supply device is configured to humidify air supplied by the air blower 31 through the humidifier 32 and then supply the humidified air to the fuel cell stack 10.

Meanwhile, in the fuel cell system, nitrogen in the air supplied to an air electrode (cathode) and water (water and stem) generated in the cathode are crossed over through an electrolytic membrane inside the stack to move to the anode based on the operation of the fuel cell stack 10. In particular, the nitrogen deteriorates the performance of the stack by reducing the partial pressure of the hydrogen, and the generated water obstructs movement of the hydrogen by blocking the flow path of a separating plate channel. Therefore, the nitrogen in the air and liquid droplets in the channel, which are crossed over, should be removed through periodic purging of the anode, to maintain stable performance of the stack.

In a fuel cell system, as the quantity of foreign matters such as nitrogen, water and steam, which are crossed over to the anode through the electrolytic membrane inside the stack, increases, the amount of hydrogen in the anode decreases, and therefore, the reaction efficiency decreases. Accordingly, a hydrogen purge valve 40 is opened based on a predetermined period to perform a purge. In other words, oxygen of the anode is periodically exhausted by installing the hydrogen purge valve 40 configured to purge hydrogen in an exit (e.g., exhaust) side line of the anode of the fuel cell stack 10, to exhaust and remove foreign matters such as moisture and nitrogen of the separating plate in the fuel cell stack 10 and to increase hydrogen utilization factor.

As the foreign matters in the fuel cell stack are exhausted as described above, hydrogen concentration may be increased to increase hydrogen utilization factor, and to improve gas diffusivity and reactivity. The hydrogen purge valve 40 is an electronic control valve periodically opened/closed based on a command of a fuel cell system controller (not shown) to manage hydrogen concentration. When the hydrogen purge value 40 is opened, the foreign matters such as moisture and nitrogen in the fuel cell stack 10 are exhausted to the air through a vehicle exhaust pipe 34. When the hydrogen purge valve 40 is opened while a vehicle is being driven, hydrogen can be exhausted to the air through the rear end of the cathode, an air exhaust line 33 and the exhaust pipe 34 due to a difference in pressure between the anode (relatively high pressure) and the cathode of the fuel cell stack 10. In particular, foreign matters are exhausted together with the hydrogen, and thus the output of the fuel cell stack can be maintained.

In the hydrogen purge, as shown in FIG. 2, a purge period is determined based on current of the stack. When the hydrogen purge is performed based on the same charge amount (based on a fixed charge amount), the purge period in a low current section of the stack is greater than that in a high current section of the stack. In particular, the amount of nitrogen crossed over under the same operating condition of the fuel cell stack is the same. Hence, when the purge period is increased, the volume of nitrogen accumulated in the hydrogen recirculation device increases, and therefore, the hydrogen concentration of the hydrogen recirculation device in the low current section is decreased.

As a result, the hydrogen recirculation performance decreases due to an increase in the amount of nitrogen recirculated, and the Stoichiometry ratio (hereinafter, referred to as “SR”) of hydrogen decreases. In particular, the SR of hydrogen may be calculated by measuring an anode entrance hydrogen concentration and an anode exit hydrogen concentration of the stack and using the following expressions.

$$Anode entrance hydrogen concentration = \frac{X}{X + Y}$$

$$Anode exit hydrogen concentration = \frac{X - C}{X - C + Y}$$

wherein, X represents a supply amount of hydrogen, Y represents a recirculation amount of nitrogen, and C represents a theoretical use amount of hydrogen (non-consideration of crossover).

When the purge reference is an operating temperature (e.g., static current condition of the stack) as shown in FIG. 3, the amount of steam back-diffused from the cathode to the anode decreases due to an increase in amount of steam exhausted from the cathode exit of the stack when the operating temperature increases compared to a target temperature under the same operating condition. Therefore, the amount of steam at the anode decreases, and therefore, the dew point decreases. As a result, the concentration of hydrogen recirculated increases, and therefore, the SR of hydrogen increases.

When the purge reference is the operating temperature as shown in FIG. 3, the quantity of liquid droplets in the hydrogen recirculation device increases, and the dew point also decreases when the operating temperature decreases under the same operating condition. In addition, the amount of nitrogen crossed over decreases. As a result, the SR of hydrogen increases.

FIG. 4 is an exemplary graph illustrating a crossover amount of hydrogen based on a stack operating pressure [M. Inaba et al./Electrochimica Acta 51 (2006) 5746-5753]. As shown in this figure, when the purge reference is an operating pressure, and the difference in pressure between the anode and cathode is 0, the amount of gas crossed over in an increase in operating pressure increases. As a result, the decrement of hydrogen concentration increases due to an increase in the crossover amount of nitrogen when the operating pressure is increased by a pressurizing operation under the same operating condition, thereby decreasing the SR of hydrogen.

Accordingly, stack current, stack operating temperature, stack operating pressure, and the like should be considered simultaneously when the purge period is determined. In the fuel cell system, the difference in pressure between the anode and cathode of the stack increases when the stack current increases. Particularly, the amount of heat generated in the stack increases, and therefore, the stack operating temperature increases. In particular, when the cooling performance of the fuel cell system is deficient, the stack operating temperature further increases, and therefore, the stack performance decreases. When the stack current increases to obtain a greater output, the difference in pressure between the anode and cathode of the stack additionally increases.

Furthermore, when the stack voltage decreases due to an increase in stack current, current limit control for decreasing the stack current and output is performed to protect the stack, and therefore, the difference in pressure between the anode and cathode of the stack and the stack operating temperature decrease. Accordingly, fuel cell operating states such as stack current, stack operating temperature and stack operating pressure are related to one another and changed in real time. Thus, when the optimal purge charge amount is derived in each operating state and then applied to hydrogen purge control, it may be possible to improve hydrogen recirculation performance and system efficiency.

### SUMMARY

The present invention provides a hydrogen purging device and method for a fuel cell system, in which the opening/closing of a hydrogen purge valve may be variably controlled based on a purge charge amount depending on an operating state of a fuel cell in the fuel cell system, to improve the hydrogen utilization factor of the fuel cell, system efficiency, hydrogen circulation performance, and the like.

In one aspect, the present invention provides a hydrogen purging device for a fuel cell system that may include: an operating state detector configured to detect an operating state of a fuel cell stack; a controller configured to determine an opening time of a hydrogen purge valve based on information regarding the stack operating state detected by the operating state detector, and output a control signal to open the hydrogen purge valve; and the hydrogen purge valve opened to hydrogen purge of the fuel cell stack in response to the control signal output from the controller. The controller may be configured to obtain every predetermined accumulation period, a variable purge charge amount that corresponds to a current stack operating state from a map, calculate a charge amount for a time period the accumulation period using a predetermined reference purge charge amount, perform accumulation by accumulating the calculated charge amount every accumulation period, and then determine the opening time of the hydrogen purge valve by comparing the accumulated charge amount with the reference purge charge amount.

In another aspect, the present invention provides a hydrogen purging method for a fuel cell system that may include: receiving and monitoring an operating state detected in real time from an operating state detector of a fuel cell stack; obtaining, every predetermined accumulation period, a variable purge charge amount that corresponds to a current stack operating state from a map; calculating a charge amount for a time period the accumulation period using a predetermined reference purge charge amount, and performing accumulation by accumulating the calculated charge amount every accumulation period; and determining an opening time of a hydrogen purge valve by comparing the accumulated charge amount with the reference purge charge amount, and opening the hydrogen purge value at the opening time.

Accordingly, in the hydrogen purging device and method for the fuel cell system according to the present invention, the opening/closing of the hydrogen purge valve may be variably controlled based on a purge charge amount depending on an operating state of the fuel cell in the fuel cell system, to improve the hydrogen utilization factor of the fuel cell, system efficiency, hydrogen circulation performance, and the like.

### BRIEF DESCRIPTION OF THE DRAWINGS

The above and other features of the present invention will now be described in detail with reference to exemplary embodiments thereof illustrated the accompanying drawings which are given hereinbelow by way of illustration only, and thus are not limitative of the present invention, and wherein:

FIG. 1 is an exemplary schematic diagram illustrating a general fuel cell system according to the related art;

FIG. 2 is an exemplary graph illustrating a purge period and a hydrogen concentration of the anode exit of a stack based on a fixed charge amount according to the related art;

FIG. 3 is an exemplary graph illustrating a Stoichiometry ratio (SR) of hydrogen and a hydrogen concentration of the anode exit of the stack based on an operating temperature of the stack according to the related art;

FIG. 4 is an exemplary graph illustrating a crossover amount of hydrogen based on an operating pressure of the stack according to the related art;

FIG. 5 is an exemplary block diagram illustrating the configuration of a hydrogen purging device according to an exemplary embodiment of the present invention;

FIG. 6 is an exemplary flowchart illustrating a hydrogen purging process according an exemplary embodiment of the present invention;

FIG. 7 is an exemplary graph illustrating a durability performance reduction rate of a stack based on an exit hydrogen concentration according to an exemplary embodiment of the present invention;

FIG. 8 is an exemplary graph illustrating a purge charge amount and an exit hydrogen concentration for each current section based on a purge charge amount control condition according to an exemplary embodiment of the present invention; and

FIG. 9 is an exemplary graph illustrating a concentration of hydrogen and an SR of hydrogen for each purge charge amount based on an operating temperature of the stack according to an exemplary embodiment of the present invention.

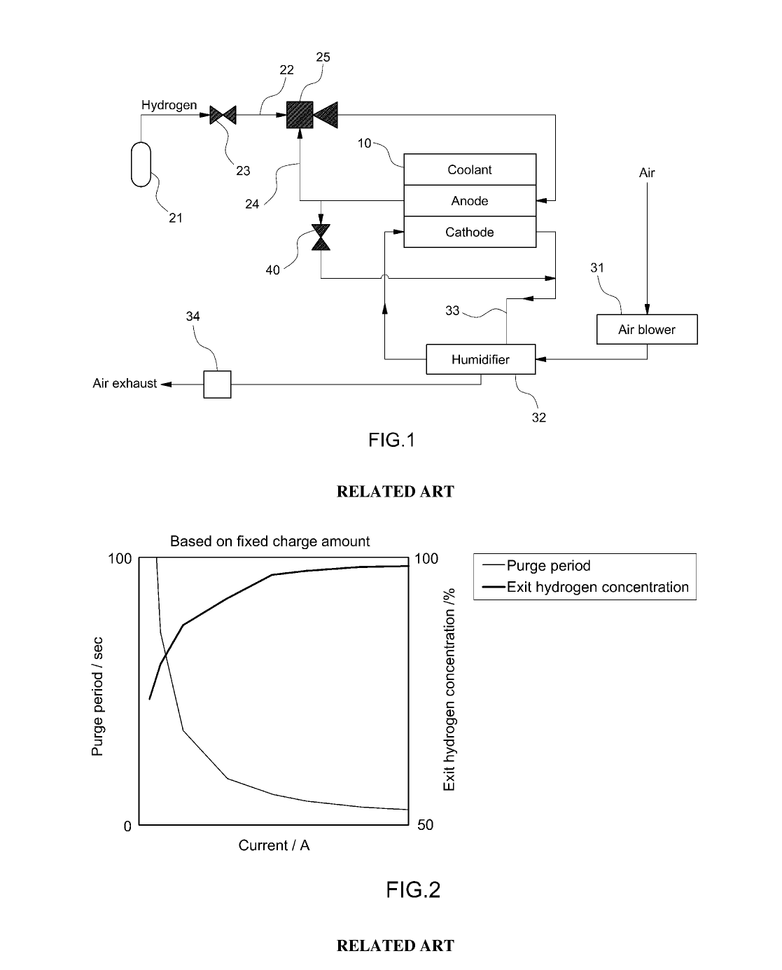

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment. In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter reference will now be made in detail to various exemplary embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

The present invention provides a hydrogen purging device and method for a fuel cell system, in which the opening/closing of a hydrogen purge valve may be variably controlled based on a purge charge amount depending on an operating state of a fuel cell in the fuel cell system to improve the hydrogen utilization factor of the fuel cell, system efficiency, hydrogen circulation performance, and the like.

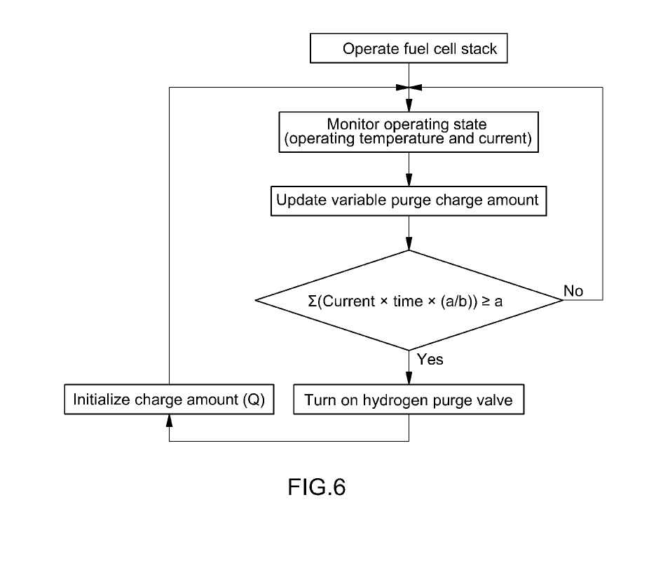

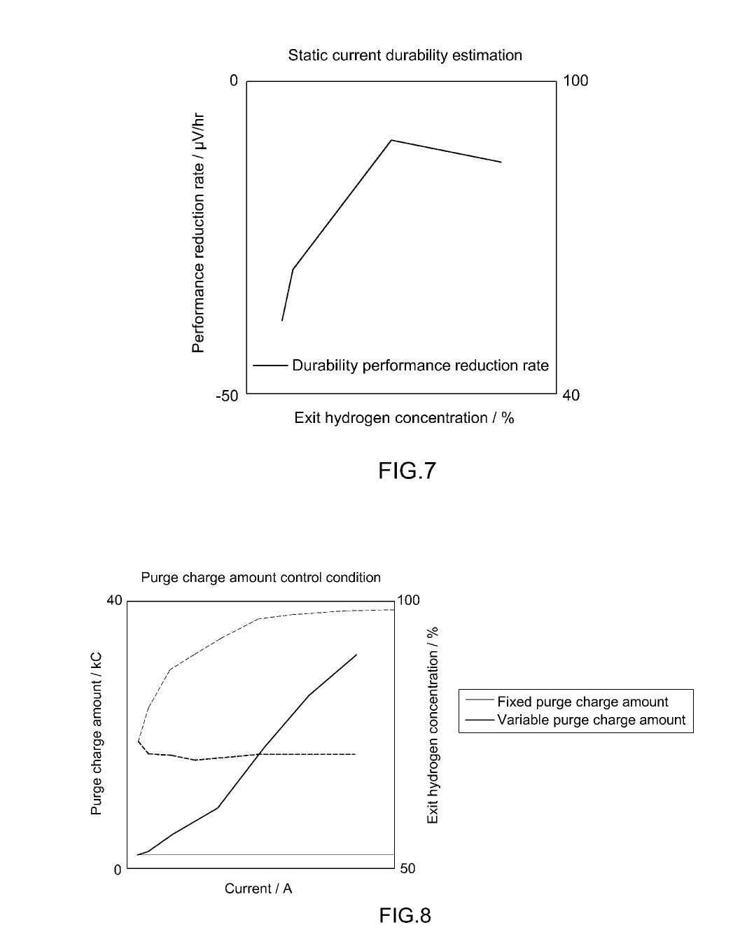

FIG. 5 is an exemplary block diagram illustrating the configuration of a hydrogen purging device according to an exemplary embodiment of the present invention. FIG. 6 is an exemplary flowchart illustrating a hydrogen purging process according an exemplary embodiment of the present invention. FIG. 7 is an exemplary graph illustrating a durability performance reduction rate of a stack based on a hydrogen concentration of an anode exit (hereinafter, referred to as an “exit hydrogen concentration”) in a fuel cell stack.

First, as shown in FIG. 5, the hydrogen purging device according to the exemplary embodiment of the present invention may include operating state detectors 1 and 2 configured to detect, in real time, an operating state of the fuel cell stack, a controller 3 configured to determine an opening time of a hydrogen purge valve based on information regarding the operating state detected by the operating state detectors and output a control signal to open the hydrogen purge valve, and when the hydrogen purge valve 4 is opened perform hydrogen purging of the fuel cell stack. In particular, the operating state of the fuel cell stack may be stack operating temperature and stack current, and the stack operating pressure may be applied in place of the stack operating temperature.

Therefore, the operating state detectors (e.g., sensors) may be an operating temperature detector 1 and a stack current detector 2. Alternatively, the operating state detectors may be an operating pressure detector and the stack current detector. The operating temperature detector 1 may be a sensor configured to detect a stack temperature. More specifically, the operating temperature detector 1 may be a temperature sensor configured to detect a cooling water temperature of a stack entrance or stack exit (e.g., exhaust). The operating pressure detector may be a pressure sensor configured to detect an operating pressure of the stack, and the stack current detector 2 may be a current sensor.

As known in the art, the controller 3 configured to operate the fuel cell system, i.e., the fuel cell system controller may be configured to obtain, in real time, a current operating state of the fuel cell stack, e.g., information regarding stack current, stack operating temperature, stack operating pressure, or the like through sensors, and operate devices in various types of systems, using information regarding the obtained operating state as an input variable.

In the present invention, the controller 3 may be configured to execute a hydrogen purge operation, i.e., an operation of the hydrogen purge valve 4, using information regarding an operating state obtained in real time during operation of the fuel cell system and the fuel cell stack. Referring to FIG. 6, a purging process according to the present invention, particularly a process of operating the hydrogen purge valve based on an operating state of the fuel cell stack is illustrated. The fuel cell system controller may be configured to receive and monitor information regarding an operating state, such as stack operating temperature and stack current, detected in real time from the operating state detectors during operation of the fuel cell stack.

In particular, the stack operating pressure may be applied as the stack operating state, in place of the stack operating temperature. The controller 3 may be configured to perform update by obtaining, every accumulation period (e.g., 100 msec), a variable purge charge amount based on the stack operating temperature and stack current obtained in real time from map data information, and reflect the obtained variable purge charge amount in current accumulation as follows. In other words, the controller 3 may be configured to calculate, every accumulation period, a charge amount (e.g., current amount) for a time that corresponds to the accumulation period, using the obtained variable purge charge amount, the stack current, and a predetermined reference purge charge amount using a predetermined calculation expression, and accumulate the calculated charge amount every accumulation period.

The controller 3 may further be configured to open the hydrogen purge valve 4 by turning on the hydrogen purge valve 4 when the charge amount accumulation value is greater than the reference purge charge amount by comparing the accumulation value with the reference purge charge amount, and then initialize the charge amount (Q). When the accumulation value is less than the reference purge charge amount, the charge amount calculation and accumulation may be continued, and the hydrogen purge value may be opened when the accumulation value is greater than the reference purge charge amount. In particular, the opening time of the hydrogen purge valve may be a previously set predetermined time, or may be a time determined based on stack current. The hydrogen purge and the control process thereof may be repeatedly performed during operation of the fuel cell stack.

Meanwhile, the reference purge charge amount may be a value obtained through a prior test repeatedly performed on the fuel cell system. The reference purge charge amount may be previously selected as a value that satisfies exit hydrogen concentration or hydrogen SR, determined by considering durability performance of the fuel cell stack, and enables the system to be operated. In the control process, the variable purge charge amount used in the charge amount calculation may be obtained from the stack operating temperature (or stack operating pressure) that is information regarding a real-time operating state of the fuel cell stack during driving of a vehicle, using map data information stored in the controller.

The map data will be described in detail. The map data may be formed by mapping the variable purge charge amount based on an operating condition of the fuel cell stack, i.e., the stack operating temperature (stack operating pressure) and the stack current. In particular, a variable purge charge amount for each operating condition may be obtained through a prior test repeatedly performed on the fuel cell system. Additionally, a hydrogen purge charge amount may be selected and used, which satisfies exit hydrogen concentration or hydrogen SR that represents the maximum durability performance of the stack for each operating condition (stack operating temperature or stack operating pressure and stack current) of the fuel cell stack.

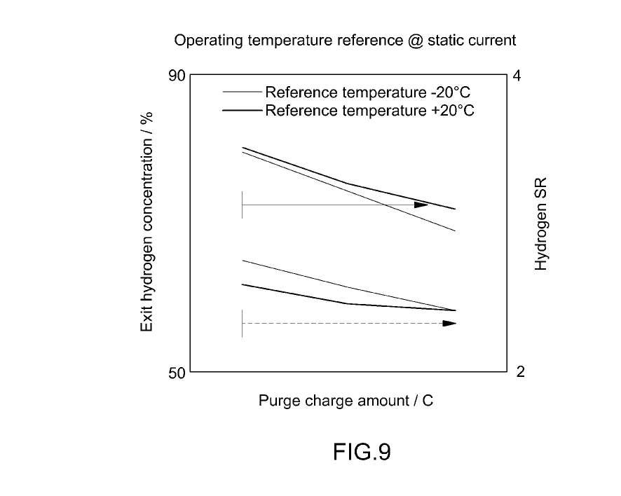

FIG. 8 is an exemplary graph illustrating a purge charge amount and an exit hydrogen concentration for each current section based on a purge charge amount control condition. FIG. 9 is an exemplary graph illustrating a concentration of hydrogen and an SR of hydrogen for each purge charge amount based on an operating temperature of the stack.

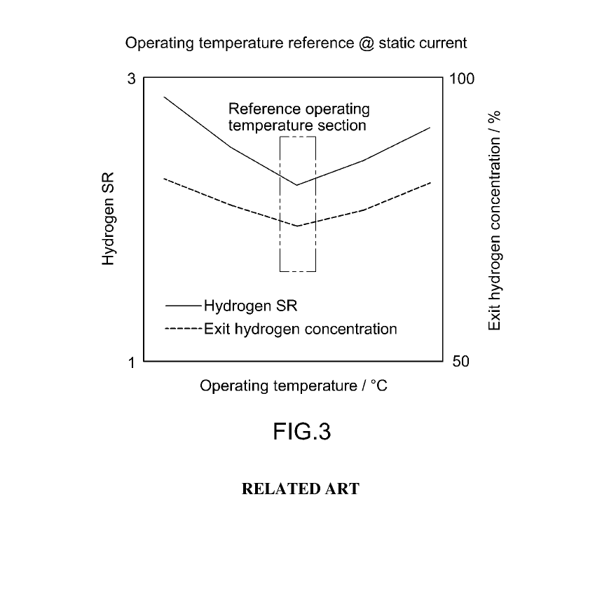

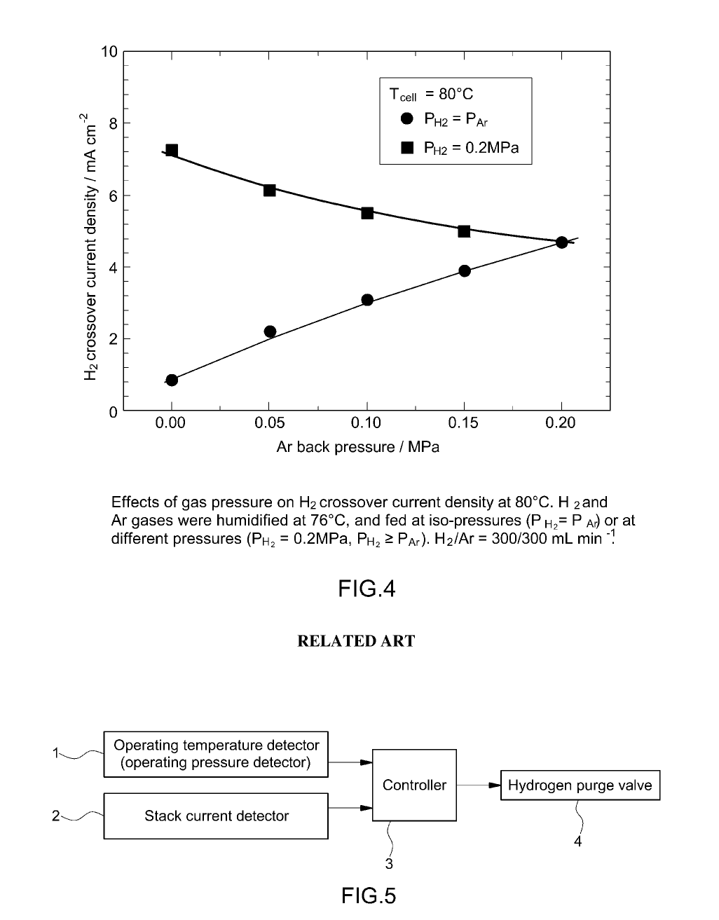

As described above, a difference may occur in the exit hydrogen concentration and the hydrogen SR based on an operating state of the stack, i.e., stack current and stack operating temperature as shown in FIGS. 2 and 3. When the purge charge amount is adjusted in the same exit hydrogen concentration based on a current section, the purge charge amount may increase as the stack current increases as shown in FIG. 8. As a result, the hydrogen utilization factor may be increased by reducing the purge charge amount.

As shown in FIG. 9, when the stack operating temperature is increased or decreased by a predetermined amount (e.g., about +20° C./−20° C.) compared to a reference temperature, the exit hydrogen concentration (e.g., the exhaust hydrogen concentration) and the hydrogen SR may be increased compared to the reference temperature even when the purge charge amount increases compared to the reference purge charge amount at the reference temperature. In addition, the hydrogen SR may be increased by a decrease in steam partial pressure even when the exit hydrogen concentration is substantially low.

Accordingly, the purge charge amount may be related to the exit hydrogen concentration and the hydrogen SR in the operation of the fuel cell stack. Thus, the optimal purge charge amount for each operating condition (e.g., stack operating temperature or stack operating pressure and stack current) may be selected and mapped based on the exit hydrogen concentration or hydrogen SR that satisfies durability performance through the prior test in the formation of map data for determining the purge charge amount.

Referring to FIG. 9, in the comparison of stack performance reduction rate according to hydrogen concentration, there occurs a section in which the performance may rapidly deteriorate based on an exit hydrogen concentration. Based on this result, the inflection point of a performance graph may be selected as a reference of exit hydrogen concentration. A variable purge charge amount satisfying the reference of exit hydrogen concentration may be derived from each operating condition, and the derived references may be used to form map data.

For example, a hydrogen purge charge amount of about 4000 C, which is a condition satisfying a stack operating temperature of about 60° C., a stack current about 50 A and an exit hydrogen concentration of about 80% in a vehicle as a stack operating reference, may be set as a reference purge charge amount. As a result, according to the map data described above, update may be performed by obtaining, in real time, a variable purge charge amount that corresponds to an operating state of the fuel cell stack, monitored in real time, i.e., a current stack operating temperature (or stack operating pressure) and stack current, and the updated variable purge charge amount may be reflected in current accumulation.

The charge amount accumulation process in the control process of FIG. 6 will be described in detail. The controller may be configured to calculate a charge amount using the variable purge charge amount obtained from the map data. In particular, the charge amount may be obtained from the following calculation expression, using the stack current, the variable purge charge amount, the reference purge charge amount and the accumulation period (e.g., 100 msec).

Charge amount=current (A)×time (sec) of accumulation period×a(C)/b(C)

wherein, a represents a reference purge charge amount, b represents a variable purge charge amount, and a/b represents a variable purge factor.

For example, when the reference purge charge amount is about 4000 C when the accumulation period is set as about 100 msec as shown in FIG. 7, and the stack temperature, the stack current and the variable charge amount are respectively obtained as about 70° C., 100 A and 8000 C from the map data, the charge amount may be (C)=100 A×0.1 sec×(4000/8000)=5.

The accumulation may be performed by accumulating in real time charge amounts calculated every accumulation period as described above, and the accumulation value may then be compared with the reference purge charge amount. When the accumulation is greater than the reference purge charge amount, the hydrogen purge valve may be turned on, thereby performing hydrogen purge variable control. The accumulation of charge amounts is expressed as follows.

Accumulation value=Σ(current×accumulation time×a/b)

As described above, according to the hydrogen purging device and method of the present invention, the opening of the hydrogen purge valve may be determined using a purge charge amount varied based on an operating state of the fuel cell stack, to improve the hydrogen utilization factor of the fuel cell and the efficiency of the fuel cell system compared to the conventional art in which the purge charge amount is fixed.

The invention has been described in detail with reference to exemplary embodiments thereof. However, it will be appreciated by those skilled in the art that changes may be made in these exemplary embodiments without departing from the principles and spirit of the invention, the scope of which is defined in the appended claims and their equivalents.

What is claimed is:

1. A hydrogen purging device for a fuel cell system, comprising:
an operating state detector configured to detect an operating state of a fuel cell stack; and
a controller configured to:
determine an opening time of a hydrogen purge valve based on information regarding the stack operating state detected by the operating state detector;
output a control signal to open the hydrogen purge valve; and
perform hydrogen purging of the fuel cell stack when the hydrogen purge valve is opened,
wherein the controller is configured to:
obtain, at every predetermined accumulation period, a variable purge charge amount that corresponds to a current stack operating state from a map′
calculate a charge amount for a time period the accumulation period using a predetermined reference purge charge amount;
perform accumulation by accumulating the calculated charge amount every accumulation period; and
determine the opening time of the hydrogen purge valve by comparing the accumulated charge amount with the reference purge charge amount.

2. The hydrogen purging device of claim 1, wherein the operating state of the fuel cell stack is a stack operating temperature and a stack current.

3. The hydrogen purging device of claim 1, wherein the operating state of the fuel cell stack is a stack operating pressure and a stack current.

4. The hydrogen purging device of claim 1, wherein the charge amount for the time that corresponds to the accumulation period is calculated by the following Expression 1;
Charge amount=current (A)×time (sec) of accumulation period×a(C)/b(C), Expression 1:
wherein a is a reference purge charge amount, and b is a variable purge charge amount.

5. The hydrogen purging device of claim 4, wherein the controller is configured to open the hydrogen purge valve when the accumulated charge amount is greater than the reference purge charge amount.

6. The hydrogen purging device of claim 5, wherein the opening time of the hydrogen purge valve is a previously set predetermined time or a time determined based on the stack current.

7. The hydrogen purging device of claim 1, wherein the operating state detector includes a plurality of sensors.

8. A hydrogen purging method for a fuel cell system, comprising:
receiving and monitoring, by a controller, an operating state detected in real time from an operating state detector of a fuel cell stack;
obtaining, by the controller, at every predetermined accumulation period, a variable purge charge amount that corresponds to a current stack operating state from a map;
calculating, by the controller, a charge amount for a time period the accumulation period using a predetermined reference purge charge amount, and performing accumulation by accumulating the calculated charge amount every accumulation period; and
determining, by the controller, an opening time of a hydrogen purge valve by comparing the accumulated charge amount with the reference purge charge amount, and opening the hydrogen purge value at the opening time.

9. The hydrogen purging method of claim 8, wherein the operating state of the fuel cell stack is a stack operating temperature and a stack current.

10. The hydrogen purging method of claim 8, wherein the operating state of the fuel cell stack is a stack operating pressure and a stack current.

11. The hydrogen purging method of claim 8, wherein the charge amount for the time that corresponds to the accumulation period is calculated by the following Expression 1;
Charge amount=current (A)×time (sec) of accumulation period×a(C)/b(C), Expression 1:
wherein a is a reference purge charge amount, and b is a variable purge charge amount.

12. The hydrogen purging method of claim 11, wherein the hydrogen purge valve is opened when the accumulated charge amount is greater than the reference purge charge amount.

13. The hydrogen purging method of claim 12, wherein the opening time of the hydrogen purge valve is a previously set predetermined time or a time determined based on the stack current.

14. A non-transitory computer readable medium containing program instructions executed by a controller, the computer readable medium comprising:
program instructions that receive and monitor an operating state detected in real time from an operating state detector of a fuel cell stack;
program instructions that obtain at every predetermined accumulation period, a variable purge charge amount that corresponds to a current stack operating state from a map;
program instructions that calculate a charge amount for a time period the accumulation period using a predetermined reference purge charge amount, and performing accumulation by accumulating the calculated charge amount every accumulation period; and
program instructions that determine an opening time of a hydrogen purge valve by comparing the accumulated charge amount with the reference purge charge amount, and opening the hydrogen purge value at the opening time.

15. The non-transitory computer readable medium of claim 14, wherein the operating state of the fuel cell stack is a stack operating temperature and a stack current.

16. The non-transitory computer readable medium of claim 14, wherein the operating state of the fuel cell stack is a stack operating temperature and a stack current.

17. The non-transitory computer readable medium of claim 14, wherein the charge amount for the time that corresponds to the accumulation period is calculated by the following Expression 1;
Charge amount=current (A)×time (sec) of accumulation period×a(C)/b(C), Expression 1:
wherein a is a reference purge charge amount, and b is a variable purge charge amount.

18. The non-transitory computer readable medium of claim 14, wherein the hydrogen purge valve is opened when the accumulated charge amount is greater than the reference purge charge amount.

19. The non-transitory computer readable medium of claim 14, wherein the opening time of the hydrogen purge valve is a previously set predetermined time or a time determined based on the stack current.
